(19) United States
(12) Patent Application Publication
(10) Pub. No.: US 2025/0004306 A1
(43) Pub. Date: Jan. 2, 2025

(54) COMPONENT OF SPECTACLES OR GOGGLE WITH INTEGRATED DECORATIVE ELEMENT AND SPECTACLES AND GOGGLE COMPRISING SUCH COMPONENT

(71) Applicant: LUXOTTICA S.R.L., Agordo (BL) (IT)

(72) Inventor: Loris CASE, La Valle Agordina (BL) (IT)

(21) Appl. No.: 18/756,776

(22) Filed: Jun. 27, 2024

(30) Foreign Application Priority Data
Jun. 30, 2023 (IT) 102023000013671

(51) Int. Cl. G02C 11/02

(52) U.S. Cl. CPC G02C 11/02

(57) ABSTRACT

A component of spectacles or goggle is described, and related spectacles or goggle having such a component; the component includes a body of component of spectacles or goggle and a decorative element made of at least one injection moldable material; wherein the decorative element is injection molded on the body.

### CROSS-REFERENCE TO RELATED APPLICATIONS

This application claims the benefit of Italian patent application 102023000013671, filed on 30 Jun. 2023, the disclosure of which is incorporated herein by reference in its entirety.

### TECHNICAL FIELD

The present disclosure relates to a component of spectacles or goggle, spectacles comprising such a component, and a goggle comprising such a component.

The present disclosure finds useful use in the field of eyewear.

### BACKGROUND

Spectacle components, such as spectacle temples or fronts or nose pads, having a decorative element are known. In particular, spectacle temples on which a logo, inscription or design, such as a brand name of the manufacturer of the same spectacles and/or a decorative element, are known. In particular, it is known to make such temples by molding by carving into each temple a seat or a special recessed portion suitable for accommodating a plate or label on which the desired logo or trademark is depicted. It is known that such a plate or label is sized to be compatible with the size of the seat on the temple and is glued into it to embellish and decorate the temple. In particular, the plate is often undersized to allow it to fit easily into the seat.

Disadvantageously, the plate, being glued, is subject to partial or total detachment over time.

Disadvantageously, the undersize of the plate relative to the seat gives rise, once the plate is glued into the seat, to the formation of an interspace between the plate and the seat, which is subject to the accumulation of dirt.

### SUMMARY

It is the purpose of the present disclosure to overcome the above-mentioned drawbacks, and in particular to conceive of a component of spectacles or goggle, spectacles comprising such a component, and a goggle comprising such a component, in which the detachment of the plate with the decorative element from the body of the temple is prevented.

Further purpose of the present disclosure is to provide a component of spectacles or goggle with a decorative element, spectacles comprising such a component and a goggle comprising such a component, which are less prone to dirt accumulation and are more durable.

Further purpose of the present disclosure is to make available a component of spectacles or goggle with a decorative element, spectacles comprising such a component and a goggle comprising such a component, which are aesthetically pleasing.

These and other purposes according to the present disclosure are achieved by making a component of spectacles or goggle as set forth in the independent claim, and by spectacles or goggle comprising such a component as set forth in further claims.

Additional features of the component of spectacles or goggle are the subject of the dependent claims.

### BRIEF DESCRIPTION OF THE DRAWINGS

The features and advantages of a component of spectacles or goggle, and of spectacles or goggle comprising such a component, according to the present disclosure will be most apparent from the following description, illustrative and not limiting, referring to the attached schematic drawings in which:

FIG. 1 shows an exploded perspective view of a component of spectacles or goggle according to the known art, which is not an aim of the present disclosure;

FIG. 2 shows a perspective view of a component of spectacles or goggle according to present the disclosure;

FIG. 3 shows a side view of a pair of spectacles comprising the component of FIG. 2;

FIG. 4 shows a perspective view of the spectacles of FIG. 3; and

FIG. 5 shows a perspective view of a goggle comprising a component of spectacles or goggle according to the present disclosure.

### DETAILED DESCRIPTION OF THE DRAWINGS

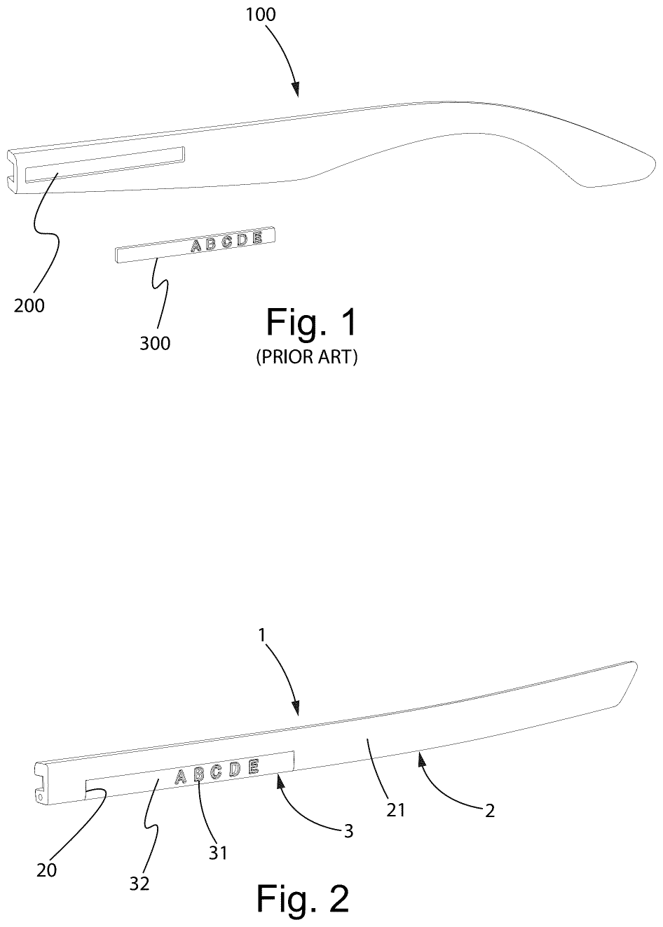

With reference to FIG. 1, there is shown a known component 100 of spectacles or goggle, not an aim of the present disclosure, comprising a seat 200 into which is glued a plate 300 bearing a logo or design or writing.

With reference to FIG. 2, a component of spectacles or goggle in accordance with the present disclosure, overall referred to as 1, is described below.

In accordance with the present disclosure, by way of example but not limitation, component 1 of spectacles or goggles is a temple. Alternatively, component 1 of spectacles or goggle may also be a front piece or part of a front piece, a nose pad, or generally any element of a spectacle frame or a frame of a goggle.

Component 1 comprises a body 2 of component of spectacle or goggle.

Component 1 also comprises a decorative element 3.

According to the present disclosure, the decorative element 3 comprises a logo and/or a design and/or a writing.

Note that, in accordance with the present disclosure, decorative element 3 is made of at least one injection moldable material. Specifically, the decorative element 3 is injection molded onto the body 2.

In other words, the body 2 has a mold surface 21 on which the decorative element 3 is injection molded.

Advantageously, decorative element 3 is intimately bonded to body 2.

Optionally, the mold surface 21 has a mechanical attachment element (not shown in the attached figures) designed to facilitate the attachment of the injected material onto the mold surface 21 to make the decorative element 3.

According to a first preferred embodiment, the body 2 has a seat 20 that is suitable for housing at least part of the decorative element 3.

The seat 20 is made on the mold surface 21.

In accordance with this embodiment, the decorative element is injection molded into said seat 20.

In other words, the decorative element 3 is obtained by injection molding the same directly inside the seat 20. For example, seat 20 is configured as a cavity or recess formed on body 2, suitable for housing decorative element 3 within it.

In other words, seat 20 is conformed to be able to inject injection moldable material into it to make decorative element 3, which remains at least partially contained, once formed, in seat 20. Advantageously, decorative element 3 is integrated into body 2. In accordance with such an embodiment, the decorative element 3 may be completely contained in the seat 20 or remain partly protruding outside the seat 20, e.g., the first element 31 and/or part of the second element 32 may be protruding outside the seat 20.

Optionally, within such a cavity or recess may be the aforementioned attachment element.

In accordance with a second embodiment, which is an alternative to the first embodiment, the decorative element 3, when molded on the body 2, is completely protruding from the body 2.

In accordance with that second embodiment, the molding surface 21 of body 2 is continuous. In other words, there is no seat 20 suitable to accommodate at least part of the decorative element 3.

Preferably, the decorative element 3 comprises a first molded injection element 31 molded at a first moment and a second molded injection element 32 molded at a second moment. In particular, the first moment and the second moment are distinct from each other.

Preferably, the second element 32 at least partially surrounds the first element 31.

More preferably, the second element 32 perimeterally surrounds the first element 31.

For example, the first element 32 represents a profile or writing, as shown in FIG. 2, and the second element 32 represents a surrounding background.

The first element 31 and the second element 32 are molded according to known methods.

In an embodiment, the second moment is subsequent to the first moment. In other words, the first element 31 is molded prior to the second element 32.

Alternatively, the second moment is prior to the first moment. In other words, the first element 31 is molded subsequent to the second element 32.

Preferably, the decorative element 3 completely fills the seat 20, if provided. Also preferably, the second element 32 fills the seat 20 from side to side, if provided.

Advantageously, there is no interspace between the seat 20 and the second element 32.

Preferably, the body 2 is obtained by molding.

Also preferably, body 2 is made of polymeric material.

For example, body 2 is made of nylon.

According to one embodiment, body 2 and decorative element 3 are made of different materials.

For example, decorative element 3 is at least partly made of polymeric material. Preferably, the decorative element 3 is at least partly made of elastomeric material.

Also preferably, the second element 32 is made of elastomeric material.

According to one embodiment, the first element 31 and the second element 32 are made of the same material. Thus, the first element 31 can also be made of elastomeric material. In accordance with such an embodiment, the first element 31 is preferably molded prior to the second element 32.

In an alternative embodiment, the first element 31 and the second element 32 are made of different materials. In accordance with such an embodiment, the first element 31 is made of metal material. In accordance with such an embodiment, the first element is over-injected on the second element 32, i.e., molded subsequently.

Preferably, the first element 31 and the second element 32 are in two or more different colors in order to form a logo and/or design and/or lettering.

The body 2 and the decorative element 3 may also be at least partially made of the same material. In particular, body 2 and first element 31 may be made in the same material. For example, both body 2 and the first element 31 are made of nylon.

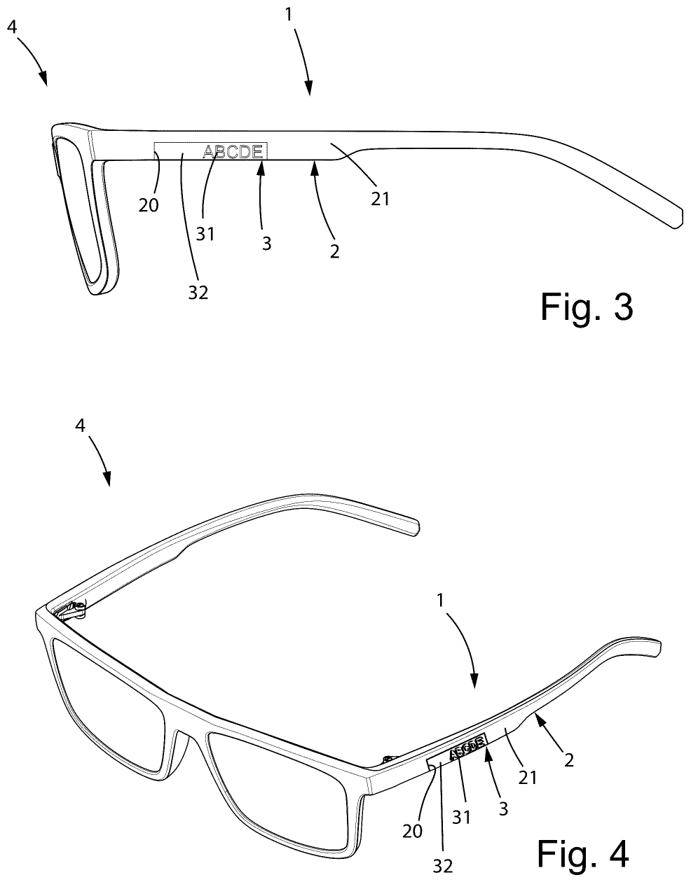

Also forming part of the present disclosure are spectacles 4, shown in FIGS. 3 and 4.

Note that the term spectacles means any type of pair of glasses, i.e., with two lenses, e.g., sunglasses, prescription, aesthetic, protective, sports, reading glasses.

Spectacles 4 comprise at least one component 1 of spectacles or goggle. Component 1 comprises a body 2 of component of spectacles or goggle and a decorative element 3 made of at least one injection moldable material, where decorative element 3 is injection molded onto body 2.

With particular reference to FIGS. 3 and 4, by way of example, component 1 is a temple.

Preferably, reference is made to the above for all features of component 1 in spectacles 4.

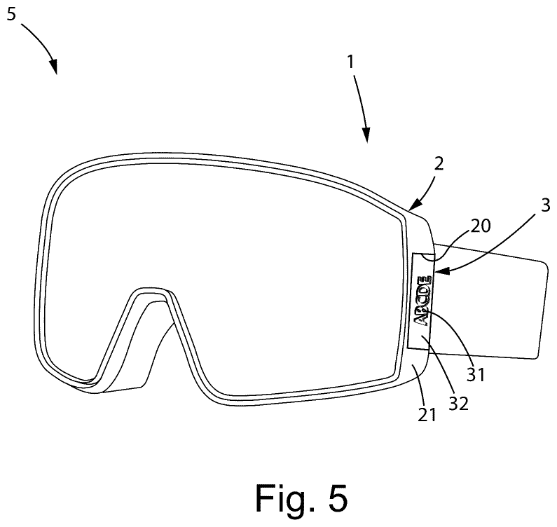

A goggle 5, shown in FIG. 5, also forms part of the present disclosure.

Note that the term goggle means any type of goggles, i.e., with a single lens, such as a sports or protective goggle or other.

Goggle 5 comprises at least one component 1 of spectacles or goggles. The component 1 comprises a body 2 of component of spectacles or goggle and a decorative element 3 made of at least one injection moldable material, wherein the decorative element 3 is injection molded onto the body 2.

With particular reference to FIG. 5, by way of example, component 1 is a side part of the front of the goggle 5. Preferably, reference is made to the above for all features of component 1 in goggle 5.

It is clear from the description made that the features of the component of spectacles or goggle and the spectacles and goggle that are the subject of the present disclosure are clear, as are the advantages thereof.

Finally, it is clear that the component of spectacles or goggle and the spectacles and goggle thus conceived are susceptible to numerous modifications and variations, all of which are within the scope of the disclosure; moreover, all details are substitutable by technically equivalent elements. In practice, the materials used, as well as the dimensions, may be any according to technical requirements.

1. A component of spectacles or goggle comprising:
a body of component of spectacles or goggle; and
a decorative element made of at least one injection moldable material, said decorative element being injection molded on said body.

2. The component according to claim 1, wherein said decorative element comprises a first element that is injection molded at a first time and a second element that is injection molded at a second time.

3. The component according to claim 1, wherein said body has a seat suitable for housing at least in part said decorative element, said decorative element being injection molded into said seat.

4. The component according to claim 1, wherein said decorative element completely fills said seat.

5. The component according to claim 1, wherein said decorative element is at least partly made of polymeric material.

6. The component according to claim 1, wherein said body and said decorative element are made of different materials.

7. The component according to claim 2, wherein said first element is made of metal material.

8. The component according to claim 2, wherein said first element and said second element are at least partly made of the same material.

9. The component according to claim 1, wherein said decorative element comprises a logo and/or a drawing and/or a writing.

10. Spectacles or goggle comprising at least one component of spectacles or goggle according to claim 1.

11. The spectacles or goggle comprising a component of spectacles or goggle comprising:
a body of component of spectacles or goggle;
a decorative element made of at least one injection moldable material, said decorative element being injection molded on said body.
